(19) United States
(12) Patent Application Publication
(10) Pub. No.: US 2008/0066674 A1
(43) Pub. Date: Mar. 20, 2008

(54) Luminescent Flagstaff and Flag

(76) Inventor: Edward T. Rockwell, Leominster, MA (US)

Correspondence Address: CARACAPPA AND ASSOCIATES, PC, 9712 FOREST ROAD, GOODE, VA, 24556, US

(21) Appl. No.: 11/858,254

(22) Filed: Sep. 20, 2007

Related U.S. Application Data
(60) Provisional application No. 60/826,229, filed on Sep. 20, 2006.

(51) Int. Cl. G09F 17/00

(52) U.S. Cl. 116/173

(57) ABSTRACT

A luminescent flagstaff and flag includes a chemiluminescent flagstaff and a flag attached to the chemiluminescent flagstaff.

### FIELD OF THE INVENTION

The present invention relates to flags and flagstaves, and in particular to providing illumination for flags mounted on flagstaves.

### BACKGROUND OF THE INVENTION

Display of flags at night requires some form of illumination in order for the flag to be visible. Regulations for display of national, state, regional, etc. flags after dark often include a requirement that the flag be illuminated. For example, the United States Flag Code recites, “ . . . when a patriotic effect is desired, the flag may be displayed 24 hours a day if properly illuminated during the hours of darkness. . . .

Various means for illuminating a flag are used. One means is to use external lighting devices pointed at the flag. Although typically these are relatively high powered lighting devices, such as spot lights, it is possible to have relatively low powered lighting devices, such as chemiluminescent devices, or light sticks, provided they are located near the flag and the flag is relatively small. Another means is to install a lighting device in the peak of the flagstaff which will illuminate the flag from the top. Another means is to install a lighting device inside the flagstaff which forms a gap in the flagstaff through which light from the lighting device passes. The gap can turn in the direction the flag is blowing so the flag is continually illuminated. A similar means is to provide a horizontally oriented hanger at the peak of a flagstaff. The flag hangs from this hanger. A lighting device in the hanger lights the length of the flag from the top. These means typically use relatively high powered lighting devices, and involve the use of electricity from electrical power mains, or automobile batteries, and also may require relatively complicated mechanical equipment.

Chemiluminescent devices, e.g. light sticks, have been used to illuminate small, decorative, novelty flags. For example, flags sized as earrings, pendants, beads, window decorations, fobs, hanging ornaments, table decorations, bolo slides, pins and the like have been fabricated with chambers into which a light stick is removably inserted, thus illuminating the flag. These are miniature flags are not displayed on flagstaves.

### BRIEF SUMMARY OF THE INVENTION

According to principles of the present invention, a luminescent flagstaff and flag includes a chemiluminescent flagstaff and a flag attached to the chemiluminescent flagstaff.

### BRIEF DESCRIPTION OF THE DRAWING

In the drawing:

FIG. 1 is an illustration of a luminescent flagstaff and flag according to principles of the present invention;

FIG. 2 is an illustration of a preferred embodiment of a luminescent flagstaff and flag according to principles of the present invention; and

FIG. 3 is a more detailed diagram of an embodiment of a flagstaff according to principles of the present invention.

### DETAILED DESCRIPTION OF THE INVENTION

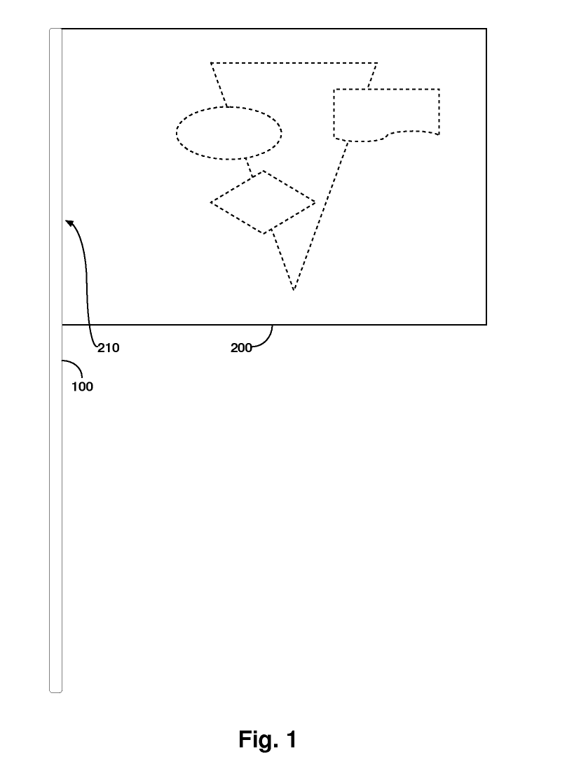

FIG. 1 is an illustration of a luminescent flagstaff 100, on which a flag 200 is attached, according to principles of the present invention. A design is illustrated on the flag 200 in FIG. 1 in dashed lines. One skilled in the art understands that the design of the flag 200 is not germane to the present invention, and may be any design in any colors, etc. In operation, the flagstaff 100 is luminescent. The flag 200 is illuminated by the luminescence from the flagstaff 100. The flag 200 may be attached to the flagstaff 100 by any means such that the illumination produced by the flagstaff 100 is not blocked from illuminating the flag 200. The flag 200 may be removable from the flagstaff 100 or may be permanently affixed to the flagstaff 100.

For example, the flag 200 may be attached to the flagstaff using adhesive. Alternatively, the flag 200 may be fabricated with a pouch at the hoist end 210, i.e. the end attached to the flagstaff 100. The pouch may be fabricated to slide over the flagstaff 100, and to be substantially transparent so that the luminescence from the flagstaff 100 is not blocked from illuminating the flag 200. In yet another example, the flag may be permanently attached, e.g. by adhesives, to a substantially transparent or translucent sleeve into which a luminescent core may be placed. Other attaching means are possible.

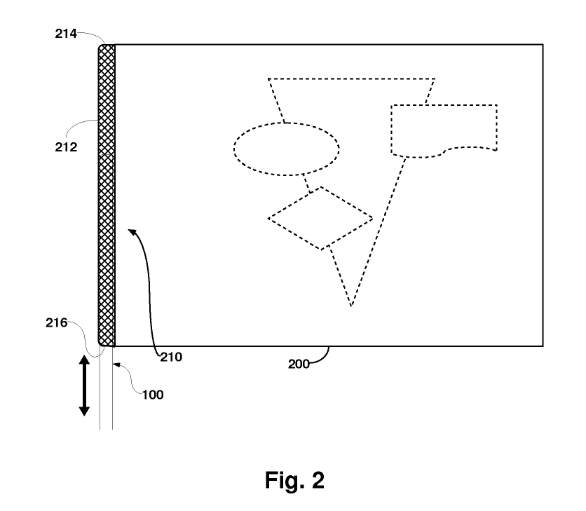

FIG. 2 is a more detailed diagram illustrating an embodiment for mounting the flag 200 on the flagstaff 100. In FIG. 2, a pouch 212 is fabricated from a mesh material. The pouch 212 forms a circular cross-section pocket which is slightly larger than the size of the circular cross-section of the flagstaff 100. The upper end 214 of the pouch 212 is closed and the bottom end 216 is open. For example, the flag 200 may be fabricated from fabric, and the mesh pouch 212 may be sewn to the hoist end 210 of the flag 200. The luminescent flagstaff 100 may be slid into the mesh pouch 212 when activated and slid out of the mesh pouch 212 when deactivated or exhausted, as illustrated by the arrow.

In general, the flagstaff 100 may be implemented as a chemiluminescent device, also known as a light stick. A light stick, when manufactured, is not luminescent, but includes the capability of becoming luminescent. When activated, the light stick becomes luminescent for a period of time which varies depending on the manufacture of that light stick. When the period of time is over, the light stick becomes non-luminescent again, and is used up.

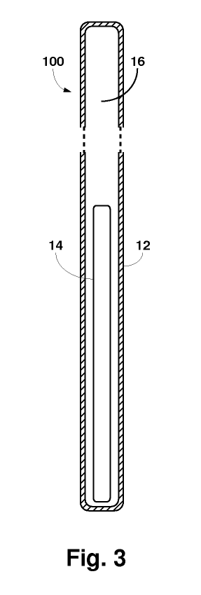

FIG. 3 is a more detailed diagram of an embodiment of a flagstaff 100 according to principles of the present invention. In FIG. 3, the flagstaff 100 is fabricated from an outer container 12 forming an inner cavity 16, and an inner ampoule 14. When fabricated, the inner ampoule 14 contains a first liquid and the inner cavity 16 formed by the outer container 12 contains the inner ampoule 14 and a second liquid. The inner ampoule 14 is fabricated from a relatively brittle material, such as glass. The outer container 12 is fabricated from a material which is stiff enough for the flag 200 (FIG. 1) to be mounted on and remain relatively straight, but is flexible enough to allow the inner ampoule 14 to be broken by flexing the outer container 12. The outer container 12 is also fabricated from a material which is substantially transparent or translucent.

In operation, a user flexes the outer container 12 of the flag staff 18 sufficiently to break the inner ampoule 14. This allows the first liquid in the ampoule 14 to mix with the second liquid in the outer container 12. When the first and second liquids mix, a chemical reaction occurs which is a source of chemical energy producing a chemiluminescence. Because the outer container 14 is substantially transparent or translucent, the chemiluminescence produced by the chemical reaction may be seen from the outside. One skilled in the art understands that different combinations of liquids may produce chemiluminescence of different colors, and understands what the chemical compositions of these liquids are. One skilled in the art further understands how to fabricate a flag staff having more than one color chemiluminescence in different locations, e.g. yellow at the bottom and green at the top, for instance. The chemical reaction, and thus the chemiluminescence, continues for a time period. At the end of the time period, the chemicals which produce the chemiluminescence are depleted and the chemiluminescence ends.

As described above with respect to FIG. 2, the flag 200 is removable from the staff 100 and includes a pouch at the hoist end 210. In this embodiment, when the chemiluminescence ends, the flag 200 may be removed from the used up light stick flagstaff. A new light stick flagstaff may then be activated and lid into the pouch at the hoist end 210 of the flag 200.

A flagstaff and flag according to the present invention may be fabricated to be self-contained. That is, no energy is required from an outside source. For a chemiluminescent flagstaff, the chemical reaction of the liquids in the flagstaff provide the luminescence.

What is claimed is:

1. A luminescent flagstaff and flag comprising:
a chemiluminescent flagstaff; and
a flag attached to the chemiluminescent flagstaff.

2. The luminescent flagstaff and flag of claim 1 wherein the flag is permanently affixed to the chemiluminescent flagstaff.

3. The luminescent flagstaff and flag of claim 1 wherein the flag is removably attached to the chemiluminescent flagstaff.

4. The luminescent flagstaff and flag of claim 3 wherein the flag comprises a pouch attached to the hoist end.

5. The luminescent flagstaff and flag of claim 4 wherein the pouch is fabricated from a mesh material.

6. The luminescent flagstaff and flag of claim 5 wherein the flag is fabric and the mesh pouch is sewn to the flag.

7. A method for fabricating a luminescent flagstaff and flag, comprising the activities of:
fabricating a chemiluminescent flagstaff;
fabricating a flag capable of attaching to the flagstaff; and
attaching the flag to the flagstaff.

8. A kit, comprising:
a chemiluminescent flagstaff; and
a flag capable of being attached to the chemiluminescent flagstaff.

9. The kit of claim 8 wherein the flag is capable of being removably attached to the chemiluminescent flagstaff.

10. The kit of claim 9 wherein the flag comprises a pouch attached to the hoist end.

11. The kit of claim 10 wherein the pouch is fabricated from a mesh material.

12. The kit of claim 11 wherein the flag is fabric and the mesh pouch is sewn to the flag.
